(19) United States
(12) Patent Application Publication
(10) Pub. No.: US 2011/0194007 A1
(43) Pub. Date: Aug. 11, 2011

(54) CMOS IMAGE SENSOR

(76) Inventors: Byung Hoon KIM, Gyunggi-do (KR); Jinwook Burm, Gyunggi-do (KR); Won Tae Choi, Gyunggi-do (KR)

(21) Appl. No.: 12/781,739

(22) Filed: May 17, 2010

(30) Foreign Application Priority Data
Feb. 5, 2010 (KR) 10-2010-0011084

(51) Int. Cl. H04N 5/335

(52) U.S. Cl. 348/308; 348/E05.091

(57) ABSTRACT

Disclosed herein is a Complementary Metal-Oxide Semiconductor (CMOS) image sensor. The CMOS image sensor includes a pixel array, a frame memory, and an analog-to-digital converter. The pixel array includes N unit pixels for converting optical signals, caused by light, into electric signals. The frame memory eliminates offset voltage included in reset voltage and signal voltage transmitted from the pixel array and internal offset voltage, and performs Correlated Double Sampling (CDS) on the reset voltage and the signal voltage. The analog-to-digital converter converts an analog signal, transmitted from the frame memory, into a digital signal.

### CROSS REFERENCE TO RELATED APPLICATION

This application claims the benefit of Korean Patent Application No. 10-2010-0011084, filed on Feb. 5, 2010, entitled “CMOS Image Sensor,” which is hereby incorporated by reference in its entirety into this application.

### BACKGROUND OF THE INVENTION

1. Technical Field

The present invention relates to Metal Complementary Oxide Semiconductor (CMOS) image sensors.

2. Description of the Related Art

In general, image sensors are installed in mobile phone cameras, digital still cameras, etc., and function to capture an image within the field of view, convert it into electric signals, convert the resulting image signals into digital signals and transmit the digital signals.

Such image sensors are classified into Charge Coupled Device (CCD) image sensors and CMOS image sensors depending on the type of transmission.

Specifically, a CCD image sensor transfers electrons, generated by light, to an output unit using gate pulses and converts them into voltages, and a CMOS image sensor converts electrons, generated by light, into voltages in respective pixels and outputs them through CMOS switches.

Accordingly, the CCD image sensor detects a signal using charge coupling and photocurrent is accumulated for a predetermined period and then extracted, so that the signal voltage can be increased in proportion to the time of accumulation. Accordingly, the CCD image sensor has the advantages of excellent photosensitivity and reduced noise, but has the disadvantages of a complicated driving method and high power consumption because photocharges are successively transmitted.

Furthermore, a CMOS image sensor is disadvantageous in that noise generated in the form of voltage during transmission is combined with an output signal because electrons generated by light are converted into voltages for respective pixels and are then transmitted, but is advantageous in that power consumption is low and the level of integration can be increased compared to a CCD image sensor.

Meanwhile, although a CMOS image sensor may be generally driven using a rolling shutter driving method or a global shutter driving method depending on the signals required for the driving of unit pixels which constitute a pixel array, the global shutter driving method is widely used in Digital Single-Lens Reflex (DSLR) cameras which provide a live viewing function using phase difference Auto Focus (AF).

In general, the conventional global shutter driving method chiefly uses a method of storing reset and signal information in DRAM-type frame memory using a single switch and a single capacitor and then reading it therefrom.

However, the conventional global shutter driving method of storing analog data in DRAM-type frame memory and using the analog data is problematic in that part of the quantity of the charge is lost because the charge of a capacitor is shared with the parasitic capacitance of a data line when a switch is turned on in order to read data, and is problematic in that a signal is distorted by signal-dependent charge injection which occurs when a switch is turned on or off.

Furthermore, the conventional global shutter driving method uses a buffer for each pixel or each column in order to read the quantity of charge stored in a capacitor. In this case, fixed pattern noise may occur due to differences in the offset of the buffer.

### SUMMARY OF THE INVENTION

Accordingly, the present invention has been made keeping in mind the above problems occurring in the prior art, and the present invention is intended to provide a CMOS image sensor which is capable of preventing the charge sharing caused when data stored in memory is read and the signal distortion caused by signal-dependent charge injection, and which is capable of preventing fixed pattern noise.

In order to accomplish the above object, the present invention provides a CMOS image sensor, including a pixel array including N unit pixels for converting optical signals, caused by light, into electric signals; a frame memory for eliminating offset voltage included in reset voltage and signal voltage transmitted from the pixel array and internal offset voltage, and performing Correlated Double Sampling (CDS) on the reset voltage and the signal voltage; and an analog-to-digital converter for converting an analog signal, transmitted from the frame memory, into a digital signal.

Each of the N unit pixels may include a reset transistor configured to operate in response to a reset control signal; a transfer transistor configured to operate in response to a transfer control signal; a photodiode connected between a source terminal and ground of the transfer transistor and configured to generate photocharge in proportion to light; a drive transistor configured to operate in response to a signal transferred to a floating diffusion node, that is, a common node between a source terminal of the reset transistor and a drain terminal of the transfer transistor; and a select transistor connected between the drive transistor and the frame memory, and configured to transfer a signal, transferred to the drive transistor, to the frame memory in response to a select control signal.

The CMOS image sensor further includes a row decoder for transferring the reset control signal, the transfer control signal and the select control signal to the unit pixel.

The frame memory may include a sample-and-hold circuit for eliminating the offset voltage included in the reset voltage and the signal voltage transferred from the pixel array, and holding the reset voltage and the signal voltage; and a CDS circuit for performing CDS on the reset voltage and the signal voltage transmitted from the sample-and-hold circuit, and then detecting difference voltage between the reset voltage and the signal voltage.

The sample-and-hold circuit may include a first inverting amplifier for performing a buffering function; a first switch and a first capacitor connected in series between an output terminal of the unit pixel and an inverting terminal of the first inverting amplifier; a second switch connected between one terminal of the first capacitor and an output terminal of the first inverting amplifier; and a third switch connected between a remaining terminal of the first capacitor and the output terminal of the first inverting amplifier.

The CDS circuit may include a second inverting amplifier for performing a buffering function; a second capacitor connected between the output terminal of the first inverting amplifier and an inverting terminal of the second inverting amplifier; a fourth switch connected between the inverting terminal of the second inverting amplifier and an output terminal of the second inverting amplifier; a third capacitor and a fifth switch connected in series between the inverting terminal of the second inverting amplifier and the output terminal of the second inverting amplifier so that they are connected in parallel to the fourth switch; a sixth switch connected between a common node between the third capacitor and the fifth switch and the ground; and a seventh switch connected between the output terminal of the second inverting amplifier and the analog-to-digital converter.

The second capacitor and the third capacitor may have identical capacitance.

The CMOS image sensor may further include a column decoder for providing first to seventh switching control signals for controlling the driving of the first to seventh switches to the frame memory.

The first switch and the third switch may be turned on simultaneously when the reset voltage and the signal voltage are transmitted from the unit pixel, and may be turned off when the reset voltage and the signal voltage are transmitted to one terminal of the first capacitor.

The second switch may be turned on after the first and third switches have been turned off, transfer the reset voltage and the signal voltage to the output terminal of the first inverting amplifier, and be turned off when the reset voltage and the signal voltage are transferred to the output terminal of the first inverting amplifier.

The fourth switch and the sixth switch may be turned on along with the first switch and the third switch when the first switch and the third switch are turned on in order to transfer the reset voltage to one terminal of the first capacitor, and be turned off along with the second switch when the second switch is turned off.

The fifth switch may be turned on along with the first switch and the third switch when the first switch and the third switch are turned on in order to transfer the signal voltage to one terminal of the first capacitor, and may be turned off along with the second switch when the second switch transfers the signal voltage to the output terminal of the first inverting amplifier and is then turned off.

### BRIEF DESCRIPTION OF THE DRAWINGS

The above and other objects, features and advantages of the present invention will be more clearly understood when the following detailed description is taken in conjunction with the accompanying drawings, in which:

FIG. 1 is a diagram showing a CMOS image sensor according to an embodiment of the present invention;

FIG. 2 is a detailed diagram showing the configuration of the pixel array and frame memory of FIG. 1;

FIG. 3 is a timing diagram showing the drive timing of the pixel array, sample-and-hold circuit and Correlated Double Sampling (CDS) circuit of FIG. 2; and

FIGS. 4 to 7 are diagrams showing the driving of the CMOS image sensor based on the drive timing of FIG. 3.

### DESCRIPTION OF THE PREFERRED EMBODIMENTS

If in the specification, detailed descriptions of well-known functions or constructions may unnecessarily make the gist of the present invention obscure, the detailed descriptions will be omitted.

The terms and words used in the present specification and the accompanying claims should not be limitedly interpreted as having their common meanings or those found in dictionaries, but should be interpreted as having meanings adapted to the technical spirit of the present invention on the basis of the principle that an inventor can appropriately define the concepts of terms in order to best describe his or her invention.

It should be noted that the same reference numerals are used throughout the different drawings to designate the same or similar components as much as possible.

Preferred embodiments of the present invention will be described in detail below with reference to the accompanying drawings.

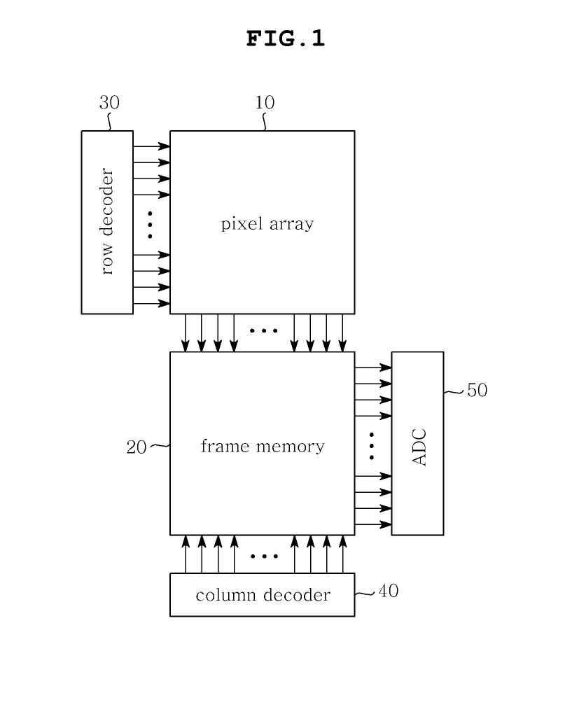

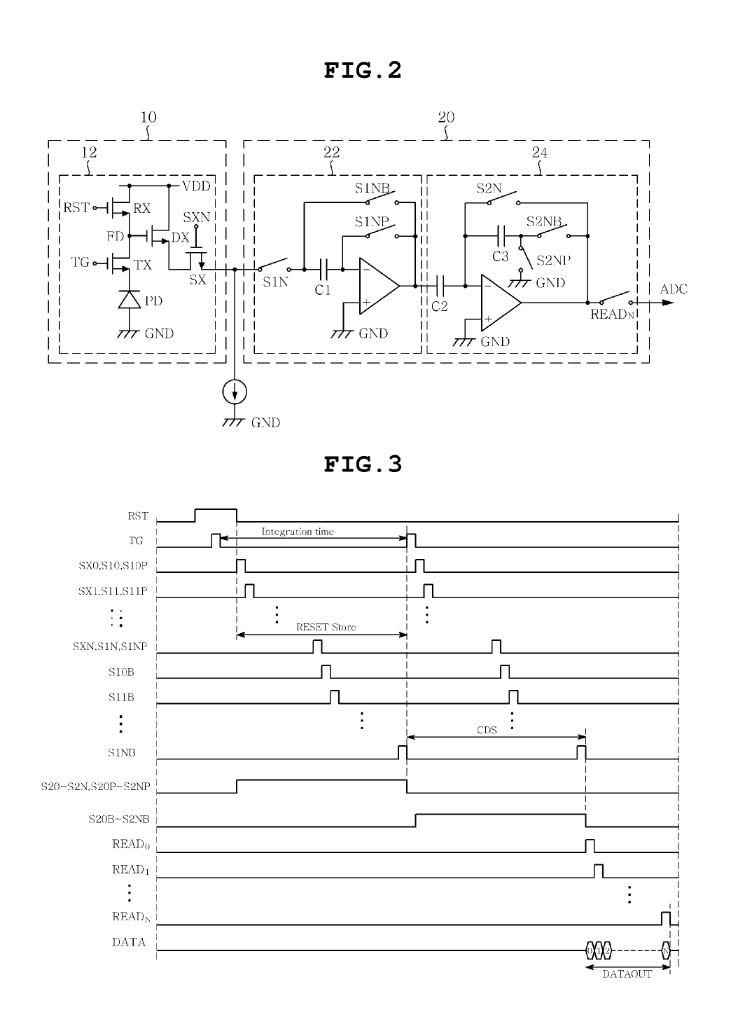

FIG. 1 is a diagram showing a CMOS image sensor according to an embodiment of the present invention, and FIG. 2 is a detailed diagram showing the configuration of the pixel array and frame memory of FIG. 1.

The CMOS image sensor according to the embodiment of the present invention, as shown in FIG. 1, includes a pixel array 10, frame memory 20, a row decoder 30, a column decoder 40, and an Analog-Digital Converter (ADC) 50.

The pixel array 10 includes N unit pixels 12, as shown in FIG. 2, and receives an optical image and converts it into an electric signal.

Here, each of the unit pixels 12 which constitute the pixel array 10 includes a photodiode PD, a transfer transistor TX, a reset transistor RX, a drive transistor DX, and a select transistor SX.

The photodiode PD is a light receiving unit which receives an external optical image, and generates optical charge in proportion to the light.

The photodiode PD is connected between the transfer transistor TX and a ground GND.

The transfer transistor TX transfers photocharges generated by the photodiode PD to the gate terminal of the drive transistor DX through a floating diffusion node FD.

For this purpose, the transfer transistor TX is configured such that the drain terminal thereof is connected to the floating diffusion node FD, the source terminal thereof is connected to the photodiode PD and the gate terminal thereof is connected to a transfer control signal input terminal TG.

The reset transistor RX applies reset voltage to the gate terminal of the drive transistor DX.

For this purpose, the reset transistor RX is disposed such that the drain terminal thereof is connected to driving power VDD, the source terminal thereof is connected to the floating diffusion node FD, and the gate terminal thereof is connected to a reset control signal input terminal RST.

Meanwhile, the drive transistor DX generates source-drain current in proportion to the magnitude of the photocharge applied to the gate terminal thereof.

For this purpose, the drive transistor DX is configured such that the drain terminal thereof is connected to the driving power VDD, the source terminal thereof is connected to the drain terminal of the select transistor SX, and the gate terminal thereof is connected to the floating diffusion node FD, that is, a common node between the drain terminal of the transfer transistor TX and the source terminal of the reset transistor RX.

The select transistor SX transfers current generated by the drive transistor DX to the sample-and-hold circuit 22 of the frame memory 20.

For this purpose, the select transistor SX is configured such that the drain terminal thereof is connected to the source terminal of the drive transistor DX, the source terminal thereof is connected to the sample-and-hold circuit 22 of the frame memory 20, and the gate terminal thereof is connected to the select control signal input terminal SXN.

The transfer transistor TX, the reset transistor RX and the select transistor SX included in the unit pixel 12 operate when control signals TG, RST and SXN are transferred from the row decoder 30 to the gate terminals.

The pixel array 10 configured as described above operates such that when HIGH-state control signals TG and RST are supplied from the row decoder 30 to the gate terminals of the transfer transistor TX and the reset transistor RX and a LOW-state control signal SXN is supplied to the gate terminal of the select transistor SX, a reset signal VRST is transferred to the drain terminal of the select transistor SX.

Furthermore, the pixel array 10 operates such that when LOW-state control signals TG and RST are supplied to the gate terminals of the transfer transistor TX and the reset transistor RX and a HIGH-state control signal SXN is supplied to the gate terminal of the reset transistor SX, the reset signal is transferred to the sample-and-hold circuit 22 of the frame memory 20.

Moreover, the pixel array 10 operates such that when a HIGH-state control signal TG is supplied from the row decoder 30 to the gate terminal of the transfer transistor TX and LOW-state control signals RST and SXN are supplied to the gate terminal of the reset transistor RX and the select transistor SX, a signal voltage SIG is transferred to the drain terminal of the select transistor SX.

Furthermore, the pixel array 10 operates such that when HIGH-state control signals TG and RST are supplied from the row decoder 30 to the gate terminals of the transfer transistor TX and the reset transistor RX and a HIGH-state control signal SXN is supplied to the gate terminal of the select transistor SX, the signal voltage SIG is transferred to the sample-and-hold circuit 22 of the frame memory 20.

The frame memory 20, as shown in FIG. 2, includes the sample-and-hold circuit 22 for removing offset voltage from the reset voltage VRST and signal voltage VSIG transmitted from the pixel array 10 and holding the reset voltage VRST and the signal voltage VSIG, and a CDS circuit 24 for performing CDS on the reset voltage VRST and signal voltage VSIG transmitted from the sample-and-hold circuit 22.

The sample-and-hold circuit 22 includes a first inverting amplifier AP1 configured to perform a buffering function, a first switch S1N and a first capacitor C1 connected in series between the output terminal of the unit pixel 12 and the inverting terminal (−) of the first inverting amplifier AP1, a second switch S1NB connected between one terminal of the first capacitor C1 and the output terminal of the first inverting amplifier AP1, and a third switch S1NP connected between the other terminal of the first capacitor C1 and the output terminal of the first inverting amplifier AP1.

Here, the first terminal of the first capacitor C1 is connected to the first switch S1N, the second terminal of the first capacitor C1 is connected to the inverting terminal of the first inverting amplifier AP1, and the output terminal of the first inverting amplifier AP1 is connected to the CDS circuit 24.

The CDS circuit 24 includes a second inverting amplifier AP2 configured to perform a buffer function, a second capacitor C2 connected between the output terminal of the first inverting amplifier AP1 and the inverting terminal (−) of the second inverting amplifier AP2, a fourth switch S2N connected between the inverting terminal of the second inverting amplifier AP2 and the output terminal of the second inverting amplifier AP2, a third capacitor C3 and a fifth switch S2NB connected in series between the inverting terminal of the second inverting amplifier AP2 and the output terminal of the second inverting amplifier AP2 so that they are connected in parallel to the fourth switch S2N, a sixth switch S2NP connected between a common node between the third capacitor C3 and the fifth switch S2NB and the ground GND, and a seventh switch READ_{N} connected between the output terminal of the ADC 50 of the second inverting amplifier AP2.

Here, the seventh switch READ_{N} is configured such that one terminal thereof is connected to a common node between the first terminals of the fourth switch S2N and the fifth switch S2NB and the output terminal of the second inverting amplifier AP2 and the other terminal thereof is connected to the ADC 50.

Meanwhile, although the second capacitor C2 and the third capacitor C3 may have the same capacitance or different capacitances, it is preferred that they have the same capacitance.

The row decoder 30 transfers control signals RST, TG and SXN for controlling the operation of the transistors TX, RX and SX, included in the pixel array 10, to the pixel array 10 in response to control signals from a CMOS Image Sensor (CIS) control unit (not shown).

The column decoder 40 transfers control signals for controlling the operation of the switches, included in the frame memory 20, to the frame memory 20 in response to control signals from the CIS control unit.

The ADC 50 converts an analog signal, transmitted from the frame memory 20, into a digital signal.

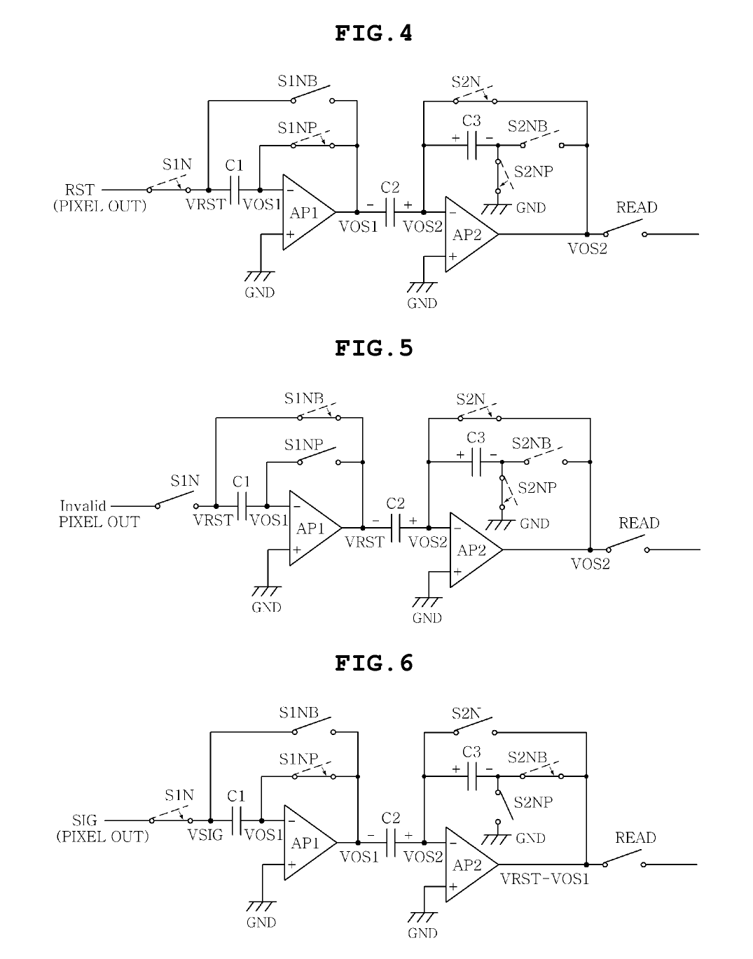

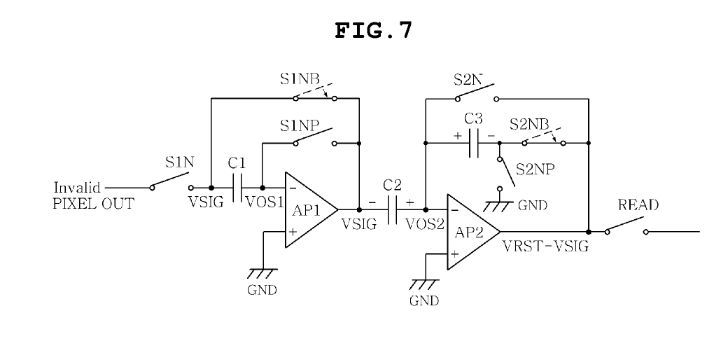

FIG. 3 is a timing diagram showing the drive timing of the pixel array, sample-and-hold circuit and Correlated Double Sampling (CDS) circuit of FIG. 2. FIGS. 4 to 7 are diagrams showing the driving of the CMOS image sensor based on the drive timing of FIG. 3.

In detail, FIG. 3 is a timing diagram showing drive timing for the driving of the pixel array 10 including N unit pixels 12, N sample-and-hold circuits 22 and N CDS circuits 24.

To perform reset sampling, the row decoder 30 provides a HIGH-state reset control signal RST to the gate terminal of the reset transistor RX, and provides a LOW-state transfer control signal TG and a LOW-state select control signal SXN to the gate terminals of the transfer transistor TX and the select transistor SX.

Accordingly, the reset transistor RX is turned on and the transfer transistor TX and the select transistor SX are turned off, so that the reset voltage VRST is applied to the gate terminal of the drive transistor DX through the floating diffusion node FD.

Furthermore, the row decoder 30 provides a HIGH-state reset control signal RST to the gate terminal of the reset transistor RX, changes a LOW-state transfer control signal TG to a HIGH state, and transfers the HIGH-state transfer control signal TG to the transfer transistor TX.

Accordingly, while the reset transistor TX remains turned on, the transfer transistor TX is turned on, and charges generated by the photodiode PD are applied to the gate terminal of the drive transistor DX through the floating diffusion node FD.

Here, the difference voltage between the reset voltage VRST and a signal voltage generated by the photodiode PD is applied to the floating diffusion node FD, that is, the gate terminal of the drive transistor DX.

Thereafter, the row decoder 30 provides a HIGH-state reset control signal RST to the gate terminal of the reset transistor RX, and provides a LOW-state transfer control signal TG to the gate terminal of the transfer transistor TX.

Accordingly, since the reset transistor RX remains turned on and the transfer transistor TX is turned off, only the reset voltage VRST is transferred to the gate terminal of the drive transistor DX.

Thereafter, the row decoder 30 provides a LOW-state reset control signal RST and a LOW-state transfer control signal TG to the gate terminals of the reset transistor RX and the transfer transistor TX, and provides a HIGH-state select control signal SXN to the gate terminal of the select transistor SX.

Accordingly, the reset transistor RX and the transfer transistor TX are turned off and the select transistor SX is turned on, the reset voltage VRST provided to the drain terminal of the select transistor SX is transferred to the sample-and-hold circuit 22 of the frame memory 20.

Meanwhile, when the row decoder 30 provides a HIGH-state select control signal SXN to the gate terminal of the select transistor SX, the column decoder 40 applies a HIGH-state first switching control signal S10˜S1N, a HIGH-state third switching control signal S10P˜S1NP, a HIGH-state fourth switching control signal S20˜S2N, and a HIGH-state sixth switching control signal S20P˜S2NP and a LOW-state second switching control signal S10B˜S1NB and a LOW-state fifth switching control signal S20B˜S2NB to the sample-and-hold circuit 22 and CDS circuit 24 of the frame memory 20.

Accordingly, as shown in FIG. 4, the first switch S1N and the third switch S1NP of the sample-and-hold circuit 22 are turned on, the second switch S1NB of the sample-and-hold circuit 22 is turned off, the fourth switch S2N and sixth switch S2NP of the CDS circuit 24 are turned on, and the fifth switch S2NB of the CDS circuit 24 is turned off.

Here, reset voltage VRST, that is, the output voltage of the pixel array 10, is applied to one terminal of the first capacitor C1 through the first switch S1N, and the offset voltage VOS1 of the first inverting amplifier AP1 is applied to the other terminal of the first capacitor C1.

Furthermore, the offset voltage VOS1 of the first inverting amplifier AP1 applied to the other terminal of the first capacitor C1 by the third switch S1NP is applied to one terminal of the second capacitor C2, and the offset voltage VOS2 of the second inverting amplifier AP2 is applied to the other terminal of the second capacitor C2.

Furthermore, the offset voltage VOS2 of the second inverting amplifier AP2 is applied to one terminal of the third capacitor C3, and the other terminal of the third capacitor C3 is connected to the ground GND.

Accordingly, the difference voltage VOS1-VRST between the offset voltage VOS1 of the first inverting amplifier AP1 and the reset voltage VRST, that is, the output voltage of the pixel array 10, in the first capacitor C1, and the difference voltage VOS2-VOS1 between the offset voltage VOS2 of the second inverting amplifier AP2 and the offset voltage VOS1 of the first inverting amplifier AP1 in the second capacitor C2.

Furthermore, the offset voltage VOS2 of the second inverting amplifier AP2 is stored in the third capacitor C3, and the offset voltage VOS2 of the second inverting amplifier AP2 is transferred to one terminal of the seventh switch READ_{N}, that is, the output terminal of the second inverting amplifier AP2.

Thereafter, the row decoder 30 supplies a LOW-state select control signal SXN to the gate terminal of the select transistor SX, and the column decoder 40 applies LOW-state first switching control signal S10˜S1N, LOW-state third switching control signal S10P˜S1NP and HIGH-state second switching control signal S10B˜S1NB to the sample-and-hold circuit 22 and CDS circuit 24 of the frame memory 20.

Accordingly, as shown in FIG. 5, the first switch S1N and third switch S1NP of the sample-and-hold circuit 22 are turned off, the second switch S1NB of the sample-and-hold circuit 22 is turned on, the fourth switch S2N and sixth switch S2NP of the CDS circuit 24 remain turned on, and the fifth switch S2NB of the CDS circuit 24 remains turned off.

Here, the reset voltage VRST, that is, the output voltage of the pixel array 10, is transferred to one terminal of the second capacitor C2, that is, the output terminal of the first inverting amplifier AP1, through the second switch S1NB.

Accordingly, the difference voltage VOS2-VRST between the offset voltage VOS2 of the second inverting amplifier AP2 and the reset voltage VRST is stored in the second capacitor C2.

When the reset voltage VRST is transferred to the sample-and-hold circuit 22 of the frame memory 20 as described above, the column decoder 40 applies LOW-state first switching control signal S10˜S1N, LOW-state second switching control signal S10B˜S1NB, LOW-state third switching control signal S10P˜S1NP, LOW-state fourth switching control signal S20˜S2N, LOW-state fifth switching control signal S20B˜S2NB and LOW-state sixth switching control signal S20P˜S2NP to the sample-and-hold circuit 22 and CDS circuit 24 of the frame memory 20.

Accordingly, the first switch S1N, the second switch S1NB, the third switch S1NP, the fourth switch S2N, the fifth switch S2NB, and the sixth switch S2NP included in the sample-and-hold circuit 22 and the CDS circuit 24 are all turned off.

Meanwhile, when the column decoder 40 supplies LOW-state switching control signals to the sample-and-hold circuit 22 and CDS circuit 24 of the frame memory 20, the row decoder 30 supplies a HIGH-state transfer control signal TG, a LOW-state reset control signal RST and a LOW-state select control signal SXN to the gate terminals of the transfer transistor TX, the reset transistor RX and the select transistor SX.

Accordingly, since the reset transistor RX and the select transistor SX are turned off and the transfer transistor TX is turned on, the signal voltage VSIG generated by the photodiode PD is transferred to the gate terminal of the drive transistor DX through the floating diffusion node FD.

Thereafter, the row decoder 30 supplies a HIGH-state select control signal SXN to the gate terminal of the select transistor SX, and supplies a LOW-state transfer control signal TG to the gate terminal of the transfer transistor TX.

Accordingly, the select transistor SX is turned on, the transfer transistor TX is turned off, and the reset transistor RX remains turned off.

When the HIGH-state select control signal SXN is transferred from the row decoder 30 to the gate terminal of the select transistor SX as described above, the select transistor SX transfers the signal voltage SIG, transferred through the drive transistor DX, to the sample-and-hold circuit 22 of the frame memory 20.

Meanwhile, when the row decoder 30 provides a HIGH-state select control signal SXN to the gate terminal of the select transistor SX, the column decoder 40 applies a HIGH-state first switching control signal S10˜S1N, a HIGH-state third switching control signal S10P˜S1NP and a HIGH-state fifth switching control signal S20B˜S2NB and a LOW-state second switching control signal S10B˜S1NB, a LOW-state fourth switching control signal S20˜S2N, and a LOW-state sixth switching control signal S20P˜S2NP to the sample-and-hold circuit 22 and CDS circuit 24 of the frame memory 20.

Accordingly, as shown in FIG. 6, the first switch S1N and third switch S1NP of the sample-and-hold circuit 22 are turned on, the second switch S1NB of the sample-and-hold circuit 22 is turned off, the fourth switch S2N and sixth switch S2NP of the CDS circuit 24 are turned off, and the fifth switch S2NB of the CDS circuit 24 is turned on.

In this case, the signal voltage SIG, that is, the output signal of the pixel array 10, is applied to one terminal of the first capacitor C1 through the first switch S1N, and the offset voltage VOS1 of the first inverting amplifier AP1 is applied to the other terminal of the first capacitor C1.

Furthermore, the offset voltage VOS1 of the first inverting amplifier AP1 applied to the other terminal of the first capacitor C1 by the third switch S1NP is applied to one terminal of the second capacitor C2, and the offset voltage VOS2 of the second inverting amplifier AP2 is applied to the other terminal of the second capacitor C2.

Moreover, the offset voltage VOS2 of the second inverting amplifier AP2 is applied to one terminal of the third capacitor C3, and the difference voltage VRST-VOS1 between the reset voltage VRST and the offset voltage VOS1 of the first inverting amplifier AP1 is applied to the other terminal of the third capacitor C3, that is, the output terminal of the second inverting amplifier AP2.

Accordingly, the difference voltage VOS1-VSIG between the offset voltage VOS1 of the first inverting amplifier AP1 and the signal voltage VSIG, that is, the output voltage of the pixel array 10, is stored in the first capacitor C1, and the difference voltage VOS2-VOS1 between the offset voltage VOS2 of the second inverting amplifier AP2 and the offset voltage VOS1 of the first inverting amplifier AP1 is stored in the second capacitor C2.

Furthermore, the difference voltage VOS2-(VRST-VOS1) between the offset voltage VOS2 of the second inverting amplifier AP2 and the difference voltage VRST-VOS1 between the reset voltage VRST and the offset voltage VOS1 of the first inverting amplifier AP1 is stored in the third capacitor C3.

The reason why the voltage VOS2-(VRST-VOS1) is stored in the third capacitor C3 is that the net charge Q1 stored in the second capacitor C2 and the third capacitor C3, as shown in FIG. 5, must be equal to the net charge Q2 stored in the second capacitor C2 and the third capacitor C3, as shown in FIG. 6, according to the law of conservation of electric charge.

That is, the net charge Q1 stored in the second capacitor C2 and the third capacitor C3 as shown in FIG. 5 is C2×(VOS2−VRST)+C3×VOS2, and the net charge Q2 stored in the second capacitor C2 and the third capacitor C3 as shown in FIG. 6 is C2×(VOS2−VOS1)+C3×(VOS2−VOUT′) (where VOUT′ is the voltage applied to one terminal of the seventh switch READ_{N}).

Here, when the capacitance of the second capacitor C2 is equal to that of the third capacitor C3, Q1=Q2 according to the law of conservation of electric charge, so that C2×(VOS2−VRST)+C3×VOS2=C2×(VOS2−VOS1)+C3×(VOS2−VOUT′), with the result that VOUT′=VRST−VOS1.

Thereafter, the row decoder 30 supplies a LOW-state select control signal SXN to the gate terminal of the select transistor SX, and the column decoder 40 applies a LOW-state first switching control signal S10˜S1N and a LOW-state third switching control signal S10P˜S1NP and a HIGH-state second switching control signal S10B˜S1NB to the sample-and-hold circuit 22 and CDS circuit 24 of the frame memory 20.

Accordingly, as shown in FIG. 7, the first switch S1N and third switch S1NP of the sample-and-hold circuit 22 are turned off, the second switch S1NB of the sample-and-hold circuit 22 is turned on, the fourth switch S2N and sixth switch S2NP of the CDS circuit 24 remains turned off, and the fifth switch S2NB of the CDS circuit 24 remains turned on.

In this case, the signal voltage VSIG, that is, the output voltage of the pixel array 10, is transferred to one terminal of the second capacitor C2, that is, the output terminal of the first inverting amplifier AP1, through the second switch S1NB.

Accordingly, the difference voltage VOS2-VSIG between the offset voltage VOS2 of the second inverting amplifier AP2 and the signal voltage VSIG is stored in the second capacitor C2.

Furthermore, the difference voltage VOS2−(VRST−VSIG) between the offset voltage VOS2 of the second inverting amplifier AP2 and the difference voltage VRST-VSIG between the reset voltage VRST and the signal voltage VSIG is stored in the third capacitor C3.

That is, the difference voltage VRST−VSIG between the reset voltage VRST and the signal voltage VSIG is transferred to the output terminal of the second inverting amplifier AP2.

The reason why the voltage VOS2−(VRST−VSIG) is stored in the third capacitor C3 is that the net charge Q2 stored in the second capacitor C2 and the third capacitor C3, as shown in FIG. 6, must be equal to the net charge Q3 stored in the second capacitor C2 and the third capacitor C3, as shown in FIG. 7, according to the law of conservation of electric charge.

That is, the net charge Q2 stored in the second capacitor C2 and the third capacitor C3 as shown in FIG. 6 is C2×(VOS2−VOS1)+C3×(VOS2−(VRST−VSIG)), and the net charge Q3 stored in the second capacitor C2 and the third capacitor C3 as shown in FIG. 7 is C2×(VOS2−VSIG)+C3×(VOS2−VOUT) (where VOUT is voltage applied to one terminal of the seventh switch READ_{N}).

In this case, when the capacitance of the second capacitor C2 is equal to that of the third capacitor C3, Q2=Q3 according to the law of conservation of electric charge, so that C2×(VOS2−VOS1)+C3×(VOS2−(VRST−VSIG))=C2×(VOS2−VSIG)+C3×(VOS2−VOUT), with the result that VOUT=VRST−VSIG.

When the CDS circuit 24 performs CDS on the reset voltage VRST and the signal voltage VSIG and detects the difference voltage VRST−VSIG between the reset voltage VRST and the signal voltage VSIG, the column decoder 40 transfers a seventh switching control signal READ₀˜READ_{N} to the seventh switch READ_{N}, and the seventh switch READ_{N} is turned on in response to the seventh switching control signal READ₀˜READ_{N}, thereby transmitting the difference voltage VRST−VSIG between the reset voltage VRST and the signal voltage VSIG to the ADC 50.

Accordingly, the ADC 50 converts the difference voltage VRST−VSIG between the reset voltage VRST and the signal voltage VSIG, transmitted from the CDS circuit 24, into a digital signal.

As described above, with regard to the CMOS image sensor according to the embodiment of the present invention, the output signal (reset voltage or signal voltage) of the pixel array 10 is stored in the sample capacitor (that is, second capacitor C2) of the sample-and-hold circuit 22 only during the operation of the source follower of the unit pixel 12, that is, the drive transistor DX, the second capacitor C2 is flipped around after the storage and then the output signal of the pixel array 10 is stored in the third capacitor C3 of the CDS circuit 24, so that a phenomenon in which the sample capacitor is shared by another parasitic capacitor does not occur, with the result that there is no loss of charge caused by charge sharing.

Furthermore, with regard to the CMOS image sensor according to the embodiment of the present invention, since one node of the sample capacitor is turned off first after the output signal (that is, reset voltage and signal voltage) of the pixel array 10 has been stored in the second capacitor C2, that is, the sample capacitor, the variation in the quantity of charge of the second capacitor C2 caused by charge stored in a signal-side switch channel does not occur, so that a signal distortion phenomenon caused by signal-dependent charge injection does not occur.

Furthermore, with regard to the CMOS image sensor according to the embodiment of the present invention, CDS is performed on the offset of the pixel array 10 and the offset of the sample-and-hold circuit 22, so that the generation of fixed pattern noise caused by the offset of the pixel array 10 and the sample-and-hold circuit 22 can be prevented.

That is, with regard to the CMOS image sensor according to the embodiment of the present invention, when the unit pixel 12 is reset by turning on the reset transistor RX and the transfer transistor TX, output signals (that is, reset voltages) occurring during the resetting of all the unit pixels 12 are temporarily stored in the floating diffusion node FD, and each of the reset output values is stored in the sample capacitor of each sample-and-hold circuit 22 by sequentially turning on the select transistor SX and the first switch S1N.

Furthermore, when an output signal occurring during the resetting of a corresponding pixel is stored in the sample capacitor, the reset output signal is stored in the second capacitor C2 of the CDS circuit 24.

When the output signals are all stored during the resetting of the overall pixel array 10, signal information (that is, signal voltage) is temporarily stored in the floating diffusion node FD by turning off the reset transistor RX and turning on the transfer transistor TX, and the signal information is stored in the sample-and-hold circuit 22 by sequentially turning on the select transistor SX and the first switch S1N using a method identical to a method by which output signals are stored during resetting.

Meanwhile, when the signal information of the corresponding pixel is all stored in the sample capacitor, CDS is performed.

In this case, since CDS is performed on the offset of the pixel array 10 and the offset of the sample-and-hold circuit 22, the offset of the pixel array 10 and the offset of the sample-and-hold circuit 22 are eliminated together.

As a result, since the sample-and-hold circuit 22 and the CDS circuit 24 output the same values during the turning off of the first switch S1N, they may be sequentially read using the column decoder 40 and then be subjected to analog-digital conversion.

According to the present invention, an output signal is stored in the sample capacitor only during the operation of the source follower, the capacitor is flipped around after the storage and then the output signal of the pixel array is stored in the capacitor for CDS, so that a phenomenon in which the sample capacitor is shared with another parasitic capacitor can be prevented, with the result that the loss of charge caused by charge sharing can be prevented.

Furthermore, according to the present invention, when the output signal is stored in the sample capacitor, one node of the sample capacitor is turned off, so that the variation in the quantity of charge of the capacitor caused by charge stored in a signal-side switch channel does not occur, with the result that a signal distortion phenomenon caused by signal-dependent charge injection does not occur.

Furthermore, according to the present invention, CDS is performed on the offset of the pixel array and the offset of the sample-and-hold circuit, so that the generation of fixed pattern noise caused by the offset can be prevented.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A Complementary Metal-Oxide Semiconductor (CMOS) image sensor, comprising:
a pixel array including N unit pixels for converting optical signals, caused by light, into electric signals;
a frame memory for eliminating offset voltage included in reset voltage and signal voltage transmitted from the pixel array and internal offset voltage, and performing Correlated Double Sampling (CDS) on the reset voltage and the signal voltage; and
an analog-to-digital converter for converting an analog signal, transmitted from the frame memory, into a digital signal.

2. The CMOS image sensor as set forth in claim 1, wherein each of the N unit pixels comprises:
a reset transistor configured to operate in response to a reset control signal;
a transfer transistor configured to operate in response to a transfer control signal;
a photodiode connected between a source terminal and ground of the transfer transistor and configured to generate photocharge in proportion to light;
a drive transistor configured to operate in response to a signal transferred to a floating diffusion node, that is, a common node between a source terminal of the reset transistor and a drain terminal of the transfer transistor; and
a select transistor connected between the drive transistor and the frame memory, and configured to transfer a signal, transferred to the drive transistor, to the frame memory in response to a select control signal.

3. The CMOS image sensor as set forth in claim 2, further comprising a row decoder for transferring the reset control signal, the transfer control signal and the select control signal to the unit pixel.

4. The CMOS image sensor as set forth in claim 1, wherein the frame memory comprises:
a sample-and-hold circuit for eliminating the offset voltage included in the reset voltage and the signal voltage transferred from the pixel array, and holding the reset voltage and the signal voltage; and
a CDS circuit for performing CDS on the reset voltage and the signal voltage transmitted from the sample-and-hold circuit, and then detecting difference voltage between the reset voltage and the signal voltage.

5. The CMOS image sensor as set forth in claim 4, wherein the sample-and-hold circuit comprises:
a first inverting amplifier for performing a buffering function;
a first switch and a first capacitor connected in series between an output terminal of the unit pixel and an inverting terminal of the first inverting amplifier;
a second switch connected between one terminal of the first capacitor and an output terminal of the first inverting amplifier; and
a third switch connected between a remaining terminal of the first capacitor and the output terminal of the first inverting amplifier.

6. The CMOS image sensor as set forth in claim 5, wherein the CDS circuit comprises:
a second inverting amplifier for performing a buffering function;
a second capacitor connected between the output terminal of the first inverting amplifier and an inverting terminal of the second inverting amplifier;
a fourth switch connected between the inverting terminal of the second inverting amplifier and an output terminal of the second inverting amplifier;
a third capacitor and a fifth switch connected in series between the inverting terminal of the second inverting amplifier and the output terminal of the second inverting amplifier so that they are connected in parallel to the fourth switch;
a sixth switch connected between a common node between the third capacitor and the fifth switch and the ground; and
a seventh switch connected between the output terminal of the second inverting amplifier and the analog-to-digital converter.

7. The CMOS image sensor as set forth in claim 6, wherein the second capacitor and the third capacitor have identical capacitance.

8. The CMOS image sensor as set forth in claim 6, further comprising a column decoder for providing first to seventh switching control signals for controlling driving of the first to seventh switches to the frame memory.

9. The CMOS image sensor as set forth in claim 6, wherein the first switch and the third switch are turned on simultaneously when the reset voltage and the signal voltage are transmitted from the unit pixel, and are turned off when the reset voltage and the signal voltage are transmitted to one terminal of the first capacitor.

10. The CMOS image sensor as set forth in claim 9, wherein the second switch is turned on after the first and third switches have been turned off, transfers the reset voltage and the signal voltage to the output terminal of the first inverting amplifier, and is turned off when the reset voltage and the signal voltage are transferred to the output terminal of the first inverting amplifier.

11. The CMOS image sensor as set forth in claim 10, wherein the fourth switch and the sixth switch are turned on along with the first switch and the third switch when the first switch and the third switch are turned on in order to transfer the reset voltage to one terminal of the first capacitor, and are turned off along with the second switch when the second switch is turned off.

12. The CMOS image sensor as set forth in claim 10, wherein the fifth switch is turned on along with the first switch and the third switch when the first switch and the third switch are turned on in order to transfer the signal voltage to one terminal of the first capacitor, and is turned off along with the second switch when the second switch transfers the signal voltage to the output terminal of the first inverting amplifier and is then turned off.
